(19) United States
(12) Patent Application Publication
(10) Pub. No.: US 2016/0112285 A1
(43) Pub. Date: Apr. 21, 2016

(54) APPARATUS AND METHOD FOR DETECTING ABNORMAL CONNECTION

(71) Applicant: SAMSUNG SDS CO., LTD., Seoul (KR)

(72) Inventors: Sung-Duc KIM, Seoul (KR); Sung-Il KIM, Seoul (KR); Gi-Duk PARK, Seoul (KR)

(73) Assignee: SAMSUNG SDS CO., LTD., Seoul (KR)

(21) Appl. No.: 14/576,725

(22) Filed: Dec. 19, 2014

(30) Foreign Application Priority Data
Oct. 20, 2014 (KR) 10-2014-0141877

(51) Int. Cl. H04L 12/26

(52) U.S. Cl. CPC H04L 43/062; H04L 43/04

(57) ABSTRACT

Disclosed are an apparatus and method for detecting an abnormal connection. The apparatus for detecting an abnormal connection includes a log pattern identifier configured to identify a plurality of connection patterns each indicating connection stages from log data regarding a system connection; and a log analyzer configured to perform at least one of a first log analysis for detecting an abnormal connection stage pair indicated by a specific connection pattern among the plurality of connection patterns and a second log analysis for detecting an abnormal connection pattern indicating a specific connection stage pair among the plurality of connection patterns.

### CROSS-REFERENCE TO RELATED APPLICATION

This application claims priority to and the benefit of Korean Patent Application No. 10-2014-0141877, filed on Oct. 20, 2014, the disclosure of which is incorporated herein by reference in its entirety.

### BACKGROUND

1. Field

Embodiments of the present disclosure relate to an apparatus and method for detecting an abnormal connection, and more particularly, to a technique for detecting a cause of a system connection failure based on log data regarding a system connection.

2. Discussion of Related Art

In general, a system that provides a service or solution using an information communication technology records a log including a variety of information, such as operating information, connection information, performance information, error information, and the like. Such a log may be used to monitor an operation of a system and to track a cause of a malfunction of the system.

When a system includes a small number of logs, an erroneous log (for example, an abnormal log that is inconsistent with a predefined service level agreement (SLA)) may be easily found depending on experience of a developer or operator of the system. However, when a system includes a large number of logs (for example, a log regarding a system connection), it is practically impossible to manually find an abnormal log and check a cause of the abnormal log, and also it is difficult to determine which part of performance improvement of the system should be achieved. Accordingly, a new approach is required to more accurately find a part that is needed to be improved in association with the system based on log data.

### SUMMARY

The present disclosure is directed to an apparatus and method for detecting an abnormal connection.

According to an aspect of the present disclosure, there is provided an apparatus for detecting an abnormal connection, the apparatus including, a log pattern identifier configured to identify a plurality of connection patterns each indicating connection stages from log data regarding a system connection, and a log analyzer configured to perform a log analysis for detecting an abnormal connection stage pair indicated by a specific connection pattern among the plurality of connection patterns.

The log analysis may include identifying a connection stage pair indicated by the specific connection pattern, and determining whether a distribution of the number of logs of the specific connection pattern with respect to a required time between two connection stages of the identified connection stage pair is normal.

The determining may include determining whether the distribution is normal by comparing a graph showing the distribution with at least one of a predetermined normal distribution graph and a predetermined abnormal distribution graph.

The log analyzer may be configured to display a graph showing the distribution.

The two connection stages may be sequentially performed during the system connection.

The log pattern identifier may be configured to generate, using the log data, a record that indicates a code of representing each connection stage, a start time of the connection stage, and an end time of the connection stage for each log regarding the system connection, and identify the plurality of connection patterns using the record.

The specific connection pattern may indicate two connection stages that are sequentially performed during the system connection, and wherein the log analyzer may be configured to identify a pair of the two connection stages, check a distribution of the number of logs of the specific connective pattern with respect to a required time between the two connection stages using the record, and determine whether the identified pair is the abnormal connection stage pair based on the distribution to perform the log analysis.

According to another aspect of the present disclosure, there is provided an apparatus for detecting an abnormal connection, the apparatus including, a log pattern identifier configured to identify a plurality of connection patterns each indicating connection stages from log data regarding a system connection, and a log analyzer configured to perform a log analysis for detecting an abnormal connection pattern indicating a specific connection stage pair among the plurality of connection patterns.

The log analysis may include identifying a connection pattern indicating the specific connection stage pair among the plurality of connection patterns, and determining whether a distribution of the number of logs of the identified connection pattern with respect to a required time between two connection stages of the specific connection stage pair is normal.

The determining may include determining whether the distribution is normal by comparing a graph showing the distribution with at least one of a predetermined normal distribution graph and a predetermined abnormal distribution graph.

The log analyzer may be configured to display a graph showing the distribution.

The two connection stages may be sequentially performed during the system connection.

The log pattern identifier may be configured to generate, using the log data, a record that indicates a code of representing each connection stage, a start time of the connection stage, and an end time of the connection stage for each log regarding the system connection, and identify the plurality of connection patterns using the record.

The specific connection stage pair may indicate a pair of two connection stages that are sequentially performed during the system connection, and wherein the log analyzer may be configured to identify a connection pattern indicating the specific connection stage pair among the plurality of connection patterns, check a distribution of the number of logs of the identified connection pattern with respect to a required time between the two connection stages, and determine whether the identified connection pattern is the abnormal connection pattern based on the distribution to perform the log analysis.

According to still another aspect of the present disclosure, there is provided an apparatus for detecting an abnormal connection, the apparatus including, a log pattern identifier configured to identify a plurality of connection patterns each indicating connection stages from log data regarding a system connection, and a log analyzer configured to perform at least one of a first log analysis for detecting an abnormal connection stage pair indicated by a specific connection pattern among the plurality of connection patterns and a second log analysis for detecting an abnormal connection pattern indicating a specific connection stage pair among the plurality of connection patterns.

According to still another aspect of the present disclosure, there is provided a method of detecting an abnormal connection, the method including, identifying a plurality of connection patterns each indicating connection stages from log data regarding a system connection, and performing a first log analysis for detecting an abnormal connection stage pair indicated by a specific connection pattern among the plurality of connection patterns.

The log analysis may include identifying a connection stage pair indicated by the specific connection pattern, and determining whether a distribution of the number of logs of the specific connection pattern with respect to a required time between two connection stages of the identified connection stage pair is normal.

The determining may include determining whether the distribution is normal by comparing a graph showing the distribution with at least one of a predetermined normal distribution graph and a predetermined abnormal distribution graph.

The method may further include displaying a graph showing the distribution.

The two connection stages may be sequentially performed during the system connection.

The identifying may include, generating, using the log data, a record that indicates a code of representing each connection stage, a start time of the connection stage, and an end time of the connection stage for each log regarding the system connection, and identifying the plurality of connection patterns using the record.

The specific connection pattern may indicate two connection stages that are sequentially performed during the system connection, and wherein the performing may include identifying a pair of the two connection stages, checking a distribution of the number of logs of the specific connective pattern with respect to a required time between the two connection stages using the record, and determining whether the identified pair is the abnormal connection stage pair based on the distribution to perform the first log analysis.

According to still another aspect of the present disclosure, there is provided a method of detecting an abnormal connection, the method including identifying a plurality of connection patterns each indicating connection stages from log data regarding a system connection, and performing a log analysis for detecting an abnormal connection pattern indicating a specific connection stage pair among the plurality of connection patterns.

The log analysis may include identifying a connection pattern indicating the specific connection stage pair among the plurality of connection patterns; and determining whether a distribution of the number of logs of the identified connection pattern with respect to a required time between two connection stages of the specific connection stage pair is normal.

The determining may include determining whether the distribution is normal by comparing a graph showing the distribution with at least one of a predetermined normal distribution graph and a predetermined abnormal distribution graph.

The method may further include displaying a graph showing the distribution.

The two connection stages may be sequentially performed during the system connection.

The identifying may include generating, using the log data, a record that indicates a code of representing each connection stage, a start time of the connection stage, and an end time of the connection stage for each log regarding the system connection, and identifying the plurality of connection patterns using the record.

The specific connection stage pair may indicate a pair of two connection stages that are sequentially performed during the system connection, and wherein the performing may include identifying a connection pattern indicating the specific connection stage pair among the plurality of connection patterns, checking a distribution of the number of logs of the identified connection pattern with respect to a required time between the two connection stages, and determining whether the identified connection pattern is the abnormal connection pattern based on the distribution to perform the log analysis.

According to still another aspect of the present disclosure, there is provided a method of detecting an abnormal connection, the method including, identifying a plurality of connection patterns each indicating connection stages from log data regarding a system connection, and performing at least one of a first log analysis for detecting an abnormal connection stage pair indicated by a specific connection pattern among the plurality of connection patterns and a second log analysis for detecting an abnormal connection pattern indicating a specific connection stage pair among the plurality of connection patterns.

According to still another aspect of the present disclosure, there is provided a computer program stored in a storage medium and configured to execute the above described method of detecting an abnormal connection in combination of hardware.

### BRIEF DESCRIPTION OF THE DRAWINGS

The above and other objects, features, and advantages of the present disclosure will become more apparent to those of ordinary skill in the art by describing in detail example embodiments thereof with reference to the accompanying drawings, in which:

FIG. 1 is a view schematically showing an apparatus for detecting an abnormal connection according to an example embodiment;

FIG. 2 is a view showing a record that is generated for each log according an example embodiment;

FIG. 3 is a view showing a connection pattern according to an example embodiment;

FIG. 4 is a view showing connection pattern information that is formatted according an example embodiment;

FIG. 5 is a view showing a log distribution for each connection stage pair in which a specific connection pattern appears according to an example embodiment;

FIGS. 6 and 7 are views each showing a log distribution for each connection pattern indicating a specific connection stage pair according to an example embodiment; and

FIG. 8 is a flowchart showing a process of detecting an abnormal connection according to an example embodiment.

### DETAILED DESCRIPTION OF EXAMPLE EMBODIMENTS

Hereinafter, embodiments of the present disclosure will be described in detail with reference to the accompanying drawings. The following detailed description will be provided for better understanding of a method, an apparatus, and/or a system that are disclosed in this specification. However, this is only example, and the present disclosure is not limited thereto.

In describing embodiments of the present disclosure, it is determined that if a detailed description of known techniques associated with the present disclosure unnecessarily may obscure the gist of the present disclosure, the detailed description thereof will be omitted. Also, the terms described below are defined in consideration of the functions in the present disclosure, and thus may vary depending on a user, intention of an operator, or custom. Accordingly, the definition would be made on the basis of the whole specification. The terminology used herein is for the purpose of only describing embodiments of the present disclosure, and should not be restrictive. The singular forms “a,” “an,” and “the” are intended to include the plural forms as well, unless the context clearly indicates otherwise. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

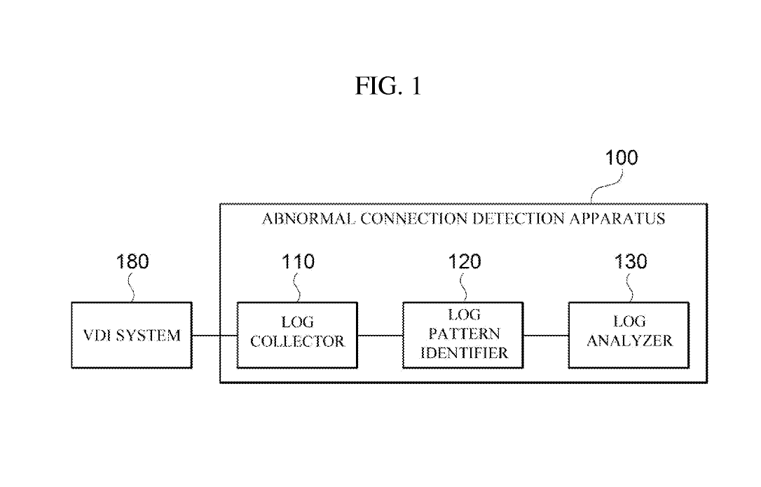

FIG. 1 is a view schematically showing an apparatus for detecting an abnormal connection according to an example embodiment.

As shown in FIG. 1, an example abnormal-connection detection apparatus 100 includes a log collector 110, a log pattern identifier 120, and a log analyzer 130. The above modules of the abnormal-connection detection apparatus 100 may be implemented with hardware. For example, the abnormal-connection detection apparatus 100 may be implemented or included in a computing apparatus. The computing apparatus may include at least one processor and a computer-readable storage medium such as a memory that is accessible by the processor. The computer-readable storage medium may be disposed inside or outside the processor, and may be connected with the processor using well known means. A computer executable instruction for controlling the computing apparatus may be stored in the computer-readable storage medium. The processor may execute an instruction stored in the computer-readable storage medium. When the instruction is executed by the processor, the instruction may allow the processor to perform an operation according to an example embodiment. In addition, the computing apparatus may further include an interface device configured to support input/output and/or communication between the computing apparatus and at least one external device, and may be connected with an external device (for example, a device in which a system that provides a service or solution and records log data regarding a system connection is implemented). Furthermore, the computing apparatus may further include various different components (for example, an input device and/or an output device), and the interface device may provide an interface for the components. Examples of the input device include a pointing device such as a mouse, a keyboard, a touch sensing input device, and a voice input device, such as a microphone. Examples of the output device include a display device, a printer, a speaker, and/or a network card. Thus, the log collector 110, a log pattern identifier 120, and a log analyzer 130 of the abnormal-connection detection apparatus 100 may be implemented as hardware of the above-described computing apparatus.

For convenience of description, an example operating environment in which the abnormal-connection detection apparatus 100 operates using log data regarding connection to a system 180 that provides a virtual desktop infrastructure (VDI) service will be described below. The VDI system 180 may include a server for providing a virtual desktop environment, thus allowing a user to access a server through a terminal such as a thin client or zero client and to perform a task in a virtual desktop environment. The VDI system 180 records a variety of data as a log on the basis of connection stages that are distinguished in detail. The abnormal-connection detection apparatus 100 may identify a pattern of the connection stages from the log data regarding connection to the VDI system 180 and may detect an abnormal connection stage pair indicated by a specific pattern and an abnormal pattern indicating a specific connection stage pair. However, such an operating environment is merely an example, and the abnormal-connection detection apparatus 100 may also be used in another type of system.

Now, each module of the abnormal-connection detection apparatus 100 is described in further detail.

The log collector 110 is configured to collect log data regarding a system connection. For example, the VDI system 180 may collect various logs such as a log including service improvement request information, a web portal log including user access information, VM operating status information, network traffic information, and the like, a desktop delivery controller (DDC) log including VM operating success/error information, a hypervisor log including hypervisor performance information, syslog information, and the like, and/or a user terminal log including an operating system (OS), a web browser, a central processing unit (CPU), a memory, and the like of a user terminal.

According to an example embodiment, some of a plurality of connection stages may occur in sequence during the connection to the VDI system 180. For example, at least some of a total of 45 connection stages are sequentially performed for system connection. For example, when it can be considered that a user terminal has connected to the VDI system 180, and a special problem has not occurred in the connection (for example, in terms of SLA), in the normal connection, a virtual machine is operated through VDI connection stages corresponding to the following 16 codes to generate a virtual machine connection record at an end stage (for example, a stage of driving a virtual machine to display a VDI service screen on a web browser such that the user may receive a VDI service).
AGENT_CHECK:START
AGENT_CHECK:END
VDIMANAGER_CHECK: START
VDIMANAGER_CHECK:END
VDIMANAGER_RUN:OK
IECONFIG:START
IECONFIG:END
PORTALVERIFY:START
PORTALVERIFY:END
CHECKVERSION:START
CHECKVERSION:OK
CHECKVERSION:END
VDISTART:OK
DDC_CALL:OK
DDC_AUTO_CALL:OK
ICA_CREATE:OK

The first seven of the sixteen connection stages that are exemplarily presented above are connection stages for environmental check. The connection stages are associated with the setting for a VDI-enabled environment (for example, setting of a reliable site, a proxy, and the like of a web browser, such as Internet Explorer (IE), and checking of a version, a logging, and whether to install associated programs of a user terminal, like a local personal computer (PC)). The next nine connection stages are for VDI authentication/connection. The connection stages are associated with generation and execution of a file to authenticate a user, check and install a VDI program, communicate with a server or DDC of a VDI, and generate a virtual machine (VM) (for example, a *.ica file supporting Independent Computing Architecture (ICA) protocol).

The log pattern identifier 120 is configured to identify a plurality of connection patterns from the collected log data. For example, each connection pattern may indicate connection stages that are sequentially performed during the connection to the VDI system 180. Particularly, each connection pattern may be a sequence that indicates corresponding connection stages in the order performed during the system connection.

According to an example embodiment, the log pattern identifier 120 may generate a single record for each log with respect to the system connection using log data and then identify a connection pattern using the single record.

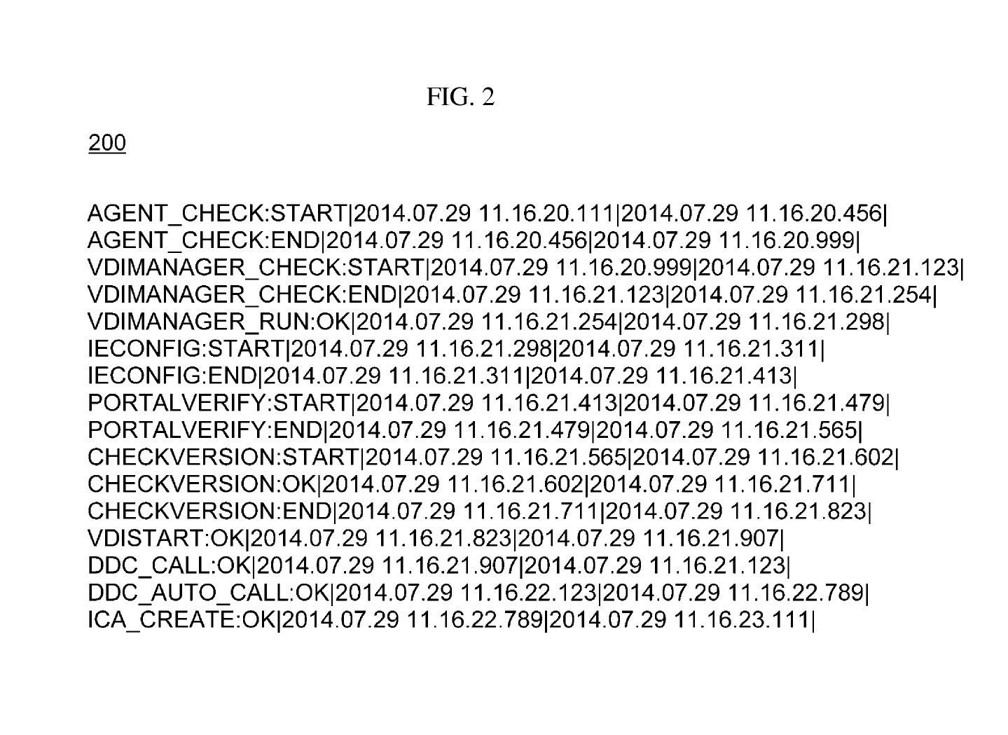

A record generated by the log pattern identifier 120 may be a continuous stream of record elements in which a code indicating a connection stage, a start time of the connection stage, and an end time of the connection stage are represented in a format of “Connection stage code|Start time|End time|.” According to the format, a log regarding a system connection that is made through the above-described 16 VDI connection stages may be converted into an example record 200 of FIG. 2. As shown in FIG. 2, the record 200 represents record elements associated with 16 connection stages in an order in which the connection stages are performed.

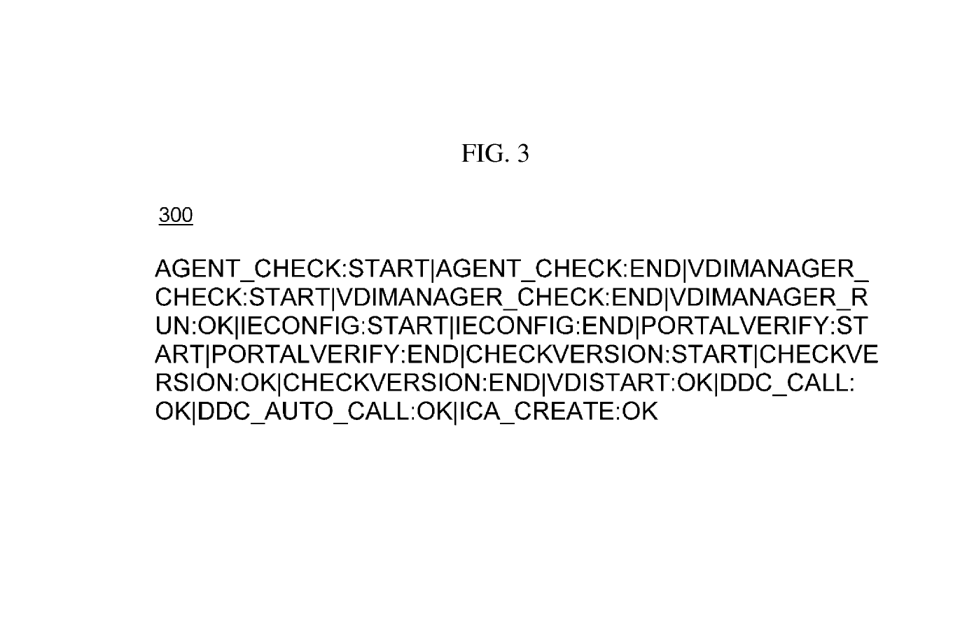

Next, the log pattern identifier 120 may group records indicating the same connection stage that is performed in the same order and identify the records as one connection pattern. For example, the log pattern identifier 120 may extract connection stage codes in a temporal sequence from the record 200 of FIG. 2 to identify a connection pattern 300 in which the connection stage codes are listed in the order as shown in FIG. 3.

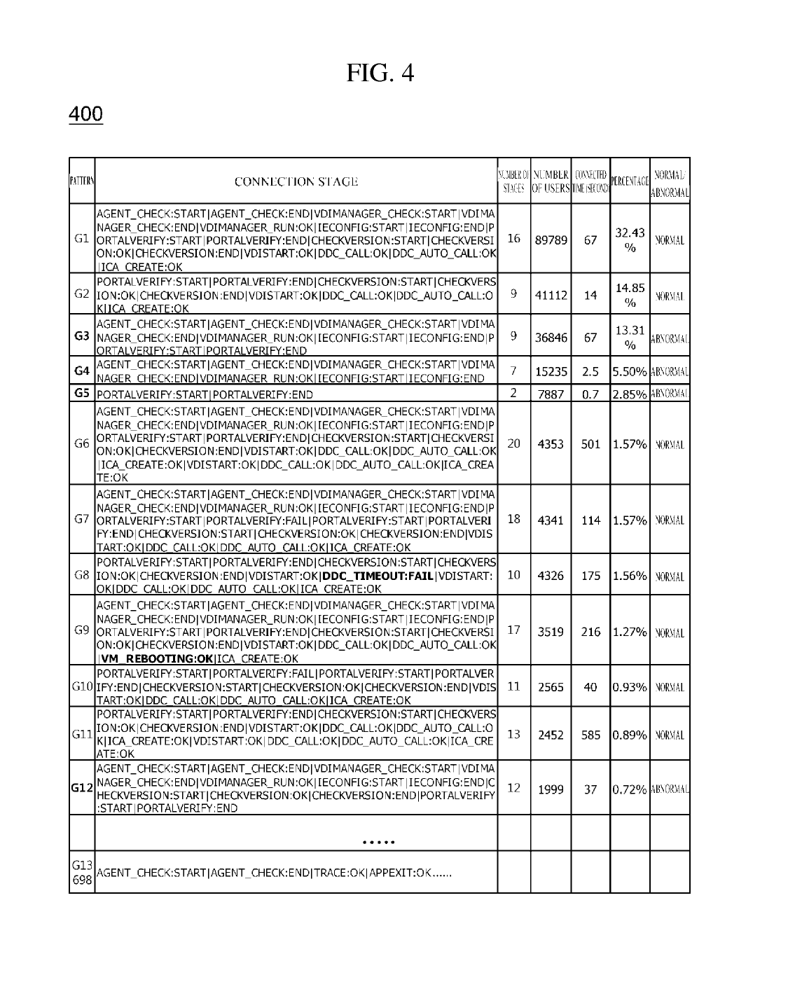

When several connection patterns are identified in the above-described scheme, the log pattern identifier 120 may record each connection pattern and data (for example, the number of connection stages that the connection pattern indicates, the number of logs that are recorded according to system connection made through the connection stage, a time required for the system connection (for example, an average time), a percentage of the connection pattern based on the number of logs, and/or normality of the system connection (for example, in terms of SLA)) associated with the connection pattern according to the format shown in FIG. 4 to generate connection pattern information 400. The total number of different connection patterns that may be identified by the log pattern identifier 120 varies depending on a structure of a service that is provided by a connected system. For example, as shown in FIG. 4, 13,698 different connection patterns may be identified. However, a considerable number of logs may be concentrated on several connection patterns having high percentages among all the connection patterns. For example, a percentage of the top 20 connection patterns may exceed 80% in the connection pattern information 400 shown in FIG. 4.

The log analyzer 130 is configured to perform at least one of a first log analysis for detecting an abnormal connection stage pair that is indicated by a specific connection pattern among identified connection patterns and a second log analysis for detecting an abnormal connection pattern that indicates a specific connection stage pair among identified connection patterns.

First, the first log analysis will be described. For example, the first log analysis may detect the abnormal connection stage pair among connection stage pairs that are indicated by each connection pattern. As another example, the first log analysis may be performed on several selected connection patterns (for example, a connection pattern having a considerable number of logs). In any case, when a system connection is made according to a specific connection pattern and a time required between two connection stages (for example, two connection stages that are sequentially performed during the system connection) in the specific connection pattern is abnormally long, the log analyzer 130 may identify a pair of the two connection stages as the abnormal connection stage pair.

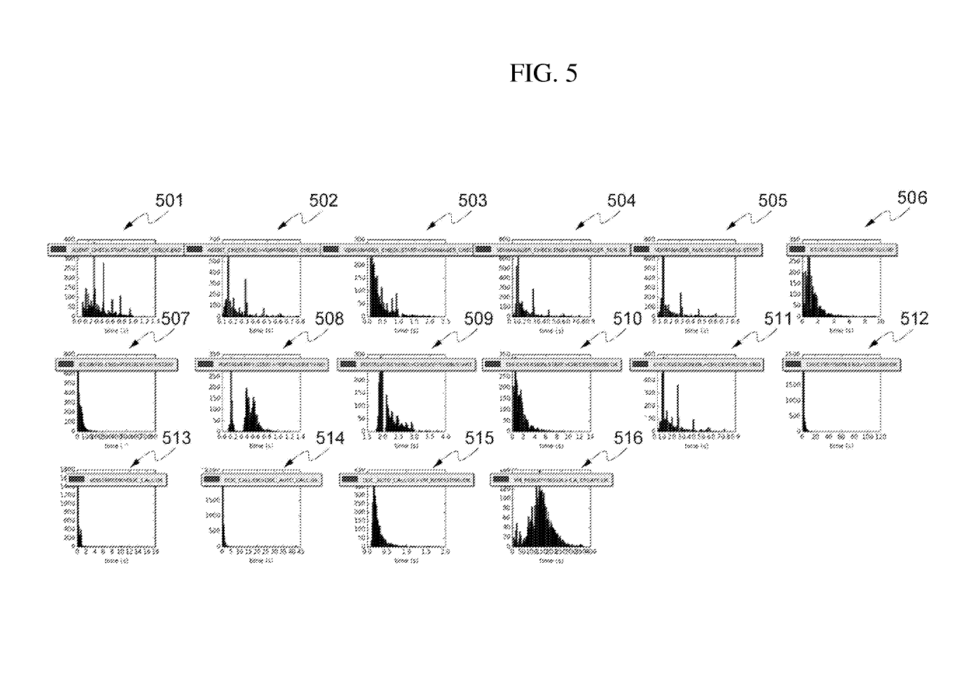

As an example, it is assumed that the log analyzer 130 performs a first log analysis on a connection pattern that is marked as “G9” (hereinafter, referred to as a “ninth connection pattern”) in the connection pattern information 400 of FIG. 4. Referring to FIG. 5, the log analyzer 130 may identify 16 connection stage pairs (each of which is a pair of two connection stages that are sequentially performed during the system connection) that are indicated by the ninth connection pattern. If a preceding connection stage and a following connection stage of any connection stage pair are represented in a format of “Foregoing connection stage code>Following connection stage code,” the above-described 16 connection stage pairs may be represented as follows.
AGENT_CHECK:START>AGENT_CHECK:END
AGENT_CHECK:END>VDIMANAGER_CHECK:START
VDIMANAGER_CHECK:START>VDIMANAGER_CHECK:END
VDIMANAGER_CHECK:END>VDIMANAGER_RUN:OK
VDIMANAGER_RUN:OK>IECONFIG:START
IECONFIG:START>IECONFIG:END
IECONFIG:END>PORTALVERIFY:START
PORTALVERIFY:START>PORTALVERIFY:END
PORTALVERIFY:END>CHECKVERSION:START
CHECKVERSION:START>CHECKVERSION:OK
CHECKVERSION:OK>CHECKVERSION:END
CHECKVERSION:END>VDISTART:OK
VDISTART:OK>DDC_CALL:OK
DDC_CALL:OK>DDC_AUTO_CALL:OK
DDC_AUTO_CALL:OK>VM_REBOOTING:OK
VM_REBOOTING:OK>ICA_CREATE:OK

Log distributions or graphs 501 to 516 that are shown for respective connection stage pairs in FIG. 5 visually represent a distribution of the number of logs of the ninth connection pattern (that is, the number of logs according to the system connection that is made through the connection stages indicated by the ninth connection pattern) with respect to a time required between two sequential connection stages. In each of the graphs 501 to 516, a horizontal axis shows a required time, and a vertical axis shows the number of logs. The log analyzer 130 may check the distribution using a record (for example, which may have the same format as the record 200 of FIG. 2) that is generated for each log of the ninth connection pattern.

Next, the log analyzer 130 may determine whether each connection stage pair is an abnormal-connection stage pair using the checked distribution. For this, the log analyzer 130 may determine whether a distribution associated with each connection stage pair is normal. For example, the log analyzer 130 may determine whether a distribution indicated by each of the graphs 501 to 516 is normal through an image comparison scheme in which each of the graphs 501 to 516 is compared with at least one predetermined normal distribution graph and/or at least one predetermined abnormal distribution graph and may identify the connection stage pair having the abnormal distribution as the abnormal connection stage pair. For example, in FIG. 5, the graph 503 is a long-tail type graph having a shape in which a tail extends long in a horizontal-axis direction (for example, the number of required times that corresponds to the number of logs exceeding a threshold value and exceeds a threshold time is equal to or greater than a reference value). The graph 508 is a multi-top type graph having several vertexes that are remarkable in a vertical-axis direction (for example, each vertex indicates the number of logs that is greater by a reference value than those of other vertexes in a certain time period around a required time corresponding to the vertex). The graph 516 is a long-time type graph having a considerably long required time between the two connection stages in which an average or median value is biased toward the right in the horizontal axis, compared to other graphs (for example, a required time corresponding to the number of logs of the average or median value exceeds a threshold time). Each of the graphs 503, 508, and 516 shows that the number of logs in which it takes no little time to perform a corresponding correction stage pair is not negligible. Further, the log analyzer 130 may check whether a graph that shows a distribution associated with each connection stage pair is at least one of a long-tail type graph, a multi-top type graph, and a long-time type graph to determine whether the distribution is normal and detect the connection stage pair as the abnormal connection stage pair when the distribution is not normal. Accordingly, the log analyzer 130 may determine that next connection stage pairs indicated by the ninth connection pattern are the abnormal connection stage pairs.
IECONFIG:START>IECONFIG:END
PORTALVERIFY:START>PORTALVERIFY:END
VM_REBOOTING:OK>ICA_CREATE:OK

It can be found from the determination that a cause of a delay that occurs when the Internet Explorer is set, connection to a web portal is checked, and/or the virtual machine is booted/generated is needed to be found and repaired.

As such, even though a distribution of the number of logs of the ninth connection pattern with respect to a time required to all connection stages of the ninth connection pattern is normal, when there is an abnormal connection stage pair indicated by the ninth connection pattern, the log analyzer 130 may detect the abnormal connection stage pair.

Next, the second log analysis will be described. The second log analysis may be performed on a connection stage pair that may be extracted from the identified connection patterns. The log analyzer 130 may detect the abnormal connection pattern among at least one connection pattern that indicates the connection stage pair. If 13,698 connection patterns illustrated in FIG. 4 are identified by the log pattern identifier 120, for example, there are a total of 850 different pairs, each of which has two sequential connection stages, in the connection patterns. The log analyzer 130 may perform a second log analysis on at least some of the connection stage pairs. In this case, when a system connection is made according to a connection pattern that indicates a specific connection stage pair and a time required between two connection stages (for example, two connection stages that are sequentially performed during the system connection) of the specific connection stage pair is abnormally long, the log analyzer 130 may identify the connection pattern as the abnormal connection pattern. For example, the log analyzer 130 may check whether a graph that shows a distribution of the number of logs of the connection pattern with respect to the required time between the two connection stages is at least one of a long-tail type graph, a multi-top type graph, and a long-time type graph to determine whether the distribution is normal and detect the connection pattern as the abnormal connection pattern when the distribution is not normal.

As an example, it is assumed that the log analyzer 130 performs a second log analysis on the connection stage pair (hereinafter, referred to as a “first connection stage pair”) that is represented as follows.
PORTALVERIFY:START>CHECKVERSION:START

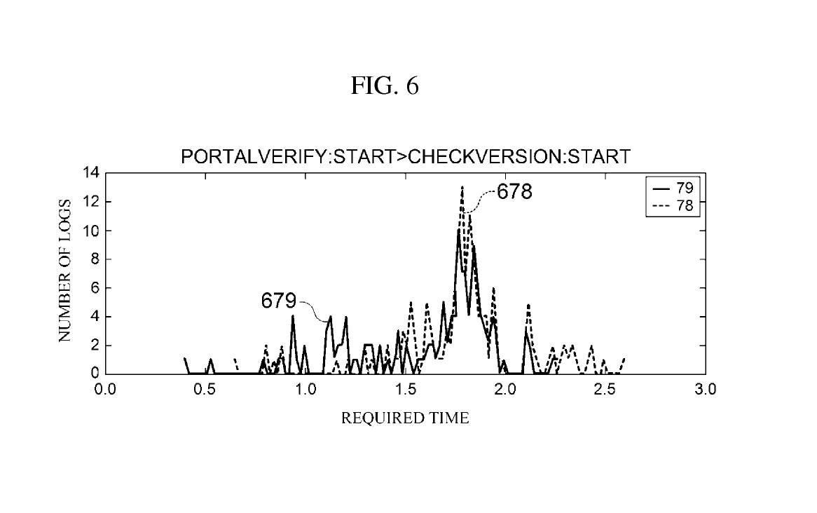

Referring to FIG. 6, the log analyzer 130 may identify two connection patterns that sequentially indicate two connection stages of the first connection stage pair. One of the two connection patterns is a connection pattern that is marked as “78” in FIG. 6 (hereinafter, referred to as a “78th connection pattern”) and the other is a connection pattern that is marked as “79” in FIG. 6 (hereinafter, referred to as a “79th connection pattern”). A log distribution or graph 678 shown in FIG. 6 visually represents a distribution of the number of logs of the 78th connection pattern with respect to a required time between the two connection stages of the first connection stage pair, and a log distribution or graph 679 visually represents a distribution of the number of logs of the 79th connection pattern with respect to the required time between the two connection stages. In each of the graphs 678 and 679, a horizontal axis shows a required time, and a vertical axis shows the number of logs. The log analyzer 130 may check each distribution using a record (for example, which may have the same format as the record 200 of FIG. 2) that is generated for each log of the 78th or 79th connection pattern.

Next, the log analyzer 130 may determine whether each of the 78th and 79th connection patterns is the abnormal connection pattern using the checked distribution. For this, the log analyzer 130 may determine whether a distribution associated with each connection pattern is normal. For example, the log analyzer 130 may determine whether a distribution indicated by each of the graphs 678 and 679 is normal through an image comparison scheme in which each of the graphs 678 and 679 is compared with at least one predetermined normal distribution graph and/or at least one predetermined abnormal distribution graph and may identify the connection pattern having the abnormal distribution as the abnormal connection pattern. For example, each of the graphs 678 and 679 of FIG. 6 is not a long-tail type graph, a multi-top type graph, or a long-time type graph, and may be determined to indicate the normal distribution.

However, it is assumed that the log analyzer 130 performs a second log analysis on the connection stage pair (hereinafter, referred to as a “second connection stage pair”) that is represented as follows.
IECONFIG:START>IECONFIG:OK

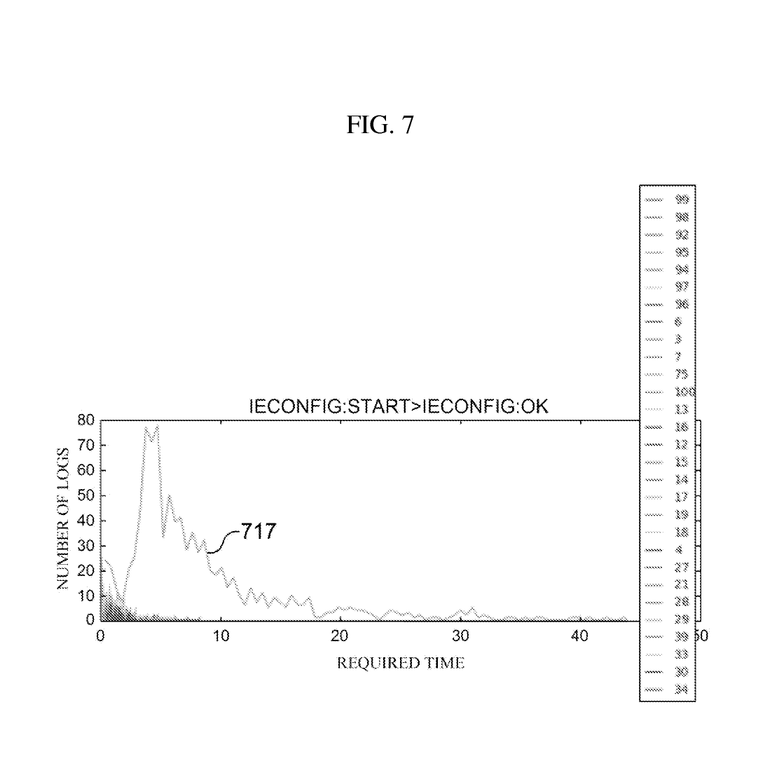

The log analyzer 130 may identify 29 connection patterns that sequentially indicate two connection stages of the second connection stage pair. FIG. 7 shows an example log distribution graph that visually represents a distribution associated with one of 29 connection patterns (horizontal axis: required time, vertical axis: the number of logs). The log analyzer 130 may check this distribution in the above-described scheme and determine whether each connection pattern is the abnormal connection pattern. For example, a graph 717 that shows a connection pattern marked as “17” (hereinafter, referred to as a “a seventeenth connection pattern”) visually represents a distribution of the number of logs of the seventeenth connection pattern with respect to a required time between the two connection stages of the second connection stage pair. However, it can be seen that, in the graph 717, an average or median value is biased toward the right, compared to other graphs shown in FIG. 7, and thus a required time between the two connection stages is considerably long. Accordingly, the log analyzer 130 may determine that the seventeenth connection pattern that indicates the second connection stage pair is the abnormal connection pattern having a long-time type log distribution. It can be found from the determination that a cause of a delay that occurs when Internet Explorer is set is needed to be found and repaired.

As such, when there is the abnormal connection pattern that indicates the second connection stage pair, the log analyzer 130 may detect the abnormal connection pattern. In particular, the second log analysis is useful to find an abnormal connection pattern among connection patterns that indicate the same connection stage pair even when there are a considerable large number of connection patterns and thus it is difficult to perform a first log analysis on all the connection patterns.

As described above, when the log analyzer 130 performs the first and/or second log analysis to detect an abnormal connection stage pair and an abnormal connection pattern that indicates the abnormal connection stage pair, a common element may be found from information about the connection pattern and the connection stage pair (for example, user environment information regarding an operating system (OS), a web browser, a central processing unit (CPU), a memory, and the like, server environment information regarding an OS, a CPU, a memory, and the like of a server that a user has accessed, and/or access time information regarding a day of the week, a time zone, and the like when the access is made). The common element may be identified using an associated-pattern analysis technique such as a frequent pattern grouping (FPG) algorithm. Since the identified common element has a high possibility that an issue of the system connection has occurred, a suitable action for solving the issue may be quickly and easily taken.

Furthermore, the log analyzer 130 may display a graph (for example, the graphs 501 to 516 of FIG. 5) that shows a distribution associated with each connection stage on the display device when performing the first log analysis. In addition, the log analyzer 130 may display a graph (for example, the graphs 678 and 679 of FIG. 6) that shows a distribution associated with each connection pattern on the display device when performing the second log analysis. Accordingly, a user of the abnormal connection detection apparatus 100 may visually check a graph that shows an issue such as an abnormal connection pattern and/or an abnormal connection stage pair.

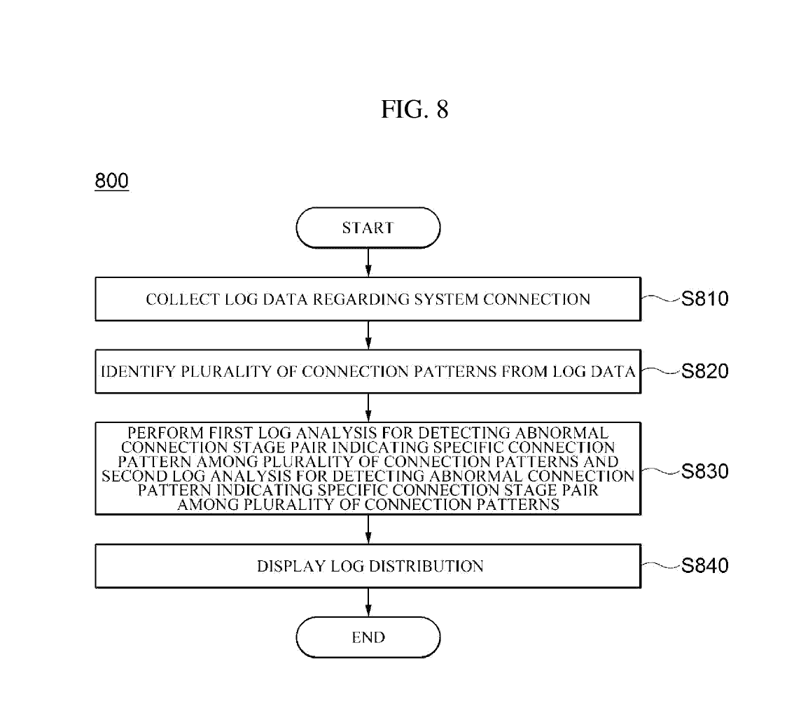

FIG. 8 shows a process of detecting an abnormal connection according to an example embodiment. For example, an example process 800 may be performed by the abnormal connection detection apparatus.

After a start operation, the process 800 proceeds to operation S810. In operation S810, log data regarding a system connection is collected. For example, the log collector 110 may collect log data regarding connection to a system (for example, the VDI system 180) that provides a certain service. A code of a connection stage that has occurred in the system connection may be recorded on the log data.

In operation S820, a plurality of connection patterns are identified from the log data. Each connection pattern may be an ordered list of connection stages that are performed during the system connection. For example, the log pattern identifier 120 may generate a record that indicates a code of representing each connection stage, a start time of the connection stage, and an end time of the connection stage for each log regarding the system connection, using the log data. Next, the log pattern identifier 120 may identify a plurality of connection patterns using the record that is generated for each log.

In operation S830, at least one of a first log analysis for detecting an abnormal connection stage pair that is indicated by a specific connection pattern among a plurality of identified connection patterns and a second log analysis for detecting an abnormal connection pattern that indicates a specific connection stage pair among the plurality of identified connection patterns is performed.

The first log analysis may include identifying a connection stage pair (for example, a pair of two connection stages that are sequentially performed during the system connection) that is indicated by a specific connection pattern and determining whether a distribution (hereinafter, referred to as a “first distribution”) of the number of logs of the specific connection pattern with respect to a required time between two connection stages of the identified connection stage pair is normal. For this determination, a graph showing the first distribution may be compared with at least one of a predetermined normal distribution graph and a predetermined abnormal distribution graph.

For example, the log analyzer 130 may identify the pair of the two connection stages, check the first distribution using the record that is generated for each log, and determine whether the identified connection stage pair is the abnormal connection stage pair based on the first distribution to perform the first log analysis.

The second log analysis may include identifying a connection pattern indicating a specific connection stage pair (for example, a pair of two connection stages that are sequentially performed during the system connection) among the plurality of connection patterns and determining whether a distribution (hereinafter, referred to as a “second distribution”) of the number of logs of the identified connection pattern with respect to a required time between two connection stages of the specific connection stage pair is normal. For this determination, a graph showing the second distribution may be compared with at least one of a predetermined normal distribution graph and a predetermined abnormal distribution graph.

For example, the log analyzer 130 may identify a connection pattern indicating the above-described specific connection stage pair among a plurality of connection patterns, check the second distribution using the record that is generated for each log, and determine whether the identified connection pattern is the abnormal connection pattern based on the second distribution to perform the second log analysis.

In operation S840, several log distributions associated with the connection pattern and the connection stage pair are displayed. For example, the log analyzer 130 may display a graph showing the first distribution and/or a graph showing the second distribution on a display device.

According to an embodiment, it is possible to detect an abnormal connection pattern and an abnormal connection stage pair using log data regarding a system connection that is made through multiple connection stages.

An embodiment facilitates performance enhancement of the system by detecting an abnormal connection stage pair indicated by a specific pattern of connection stages that are performed during the system connection and an abnormal connection pattern indicating a specific connection stage pair while performance improvement of a conventional system depends on experience of a developer or operator of the system.

According to an embodiment, it may accurately detect connection stages to be considered to improve system performance.

An example embodiment may include a computer-readable storage medium including a program for performing methods described in this specification on a computer. The computer-readable storage medium may include a program instruction, a local data file, a local data structure, or a combination thereof. The computer-readable storage medium may be designed and configured specially for the present disclosure. Examples of the computer-readable storage medium include a magnetic medium, such as a hard disk, a floppy disk, and a magnetic tape, an optical recording medium, such as a CD-ROM, a DVD, etc., a magneto-optical medium such as a floptical disk, and a hardware device specially configured to store and perform a program instruction, such as a ROM, a RAM, a flash memory, etc. Examples of the program instruction include a high-level language code executable by a computer with an interpreter, in addition to a machine language code made by a compiler.

Although example embodiments of the disclosure has been described in detail, it will be understood by those skilled in the art that various changes may be made without departing from the spirit or scope of the disclosure. Thus, the scope of the present disclosure is to be determined by the following claims and their equivalents, and shall not be restricted or limited by the foregoing detailed description.

What is claimed is:

1. An apparatus, intended for use in detecting an abnormal connection, comprising:
a log pattern identifier configured to identify a plurality of connection patterns, each indicating connection stages, from log data regarding a system connection; and
a log analyzer configured to perform a log analysis for detecting an abnormal connection stage pair, of the connection stages, indicated by a specific connection pattern among the plurality of connection patterns;
wherein the log pattern identifier and the log analyzer are implemented by at least one hardware processor.

2. The apparatus of claim 1, wherein the log analyzer is further configured to identify a connection stage pair indicated by the specific connection pattern and to determine whether a distribution of a number of log data entries corresponding to the specific connection pattern, with respect to a required time between two connection stages of the identified connection stage pair, is normal.

3. The apparatus of claim 2, wherein the log analyzer is further configured to determine whether the distribution is normal by comparing the distribution with at least one of a predetermined normal distribution and a predetermined abnormal distribution.

4. The apparatus of claim 2, wherein the log analyzer is further configured to output a graph showing the distribution.

5. The apparatus of claim 2, wherein the connection stage pair comprises two connection stages sequentially executed during the system connection.

6. The apparatus of claim 1, wherein the log pattern identifier is further configured to generate, using the log data, records representing each connection stage, a start time of the connection stage, and an end time of the connection stage for each system connection, and to identify the plurality of connection patterns using the records.

7. The apparatus of claim 6, wherein:
the specific connection pattern indicates two connection stages sequentially executed during the system connection, and
the log analyzer is further configured to identify a pair of the two connection stages, check a distribution of a number of log data entries of the specific connective pattern with respect to a required time between the two connection stages using the records, and detect the abnormal connection stage pair based on the distribution.

8. An apparatus, intended for use in detecting an abnormal connection, comprising:
a log pattern identifier configured to identify a plurality of connection patterns, each indicating connection stages, from log data regarding a system connection; and
a log analyzer configured to perform a log analysis for detecting an abnormal connection pattern indicating a specific connection stage pair of the connection stages, among the plurality of connection patterns;
wherein the log pattern identifier and the log analyzer are implemented by at least one hardware processor.

9. The apparatus of claim 8, wherein the log analyzer is further configured to identify a connection pattern, indicating the specific connection stage pair, among the plurality of connection patterns and to determine whether a distribution of a number of log data entries corresponding to the identified connection pattern, with respect to a required time between two connection stages of the specific connection stage pair, is normal.

10. The apparatus of claim 9, wherein the log analyzer is further configured to determine whether the distribution is normal by comparing the distribution with at least one of a predetermined normal distribution and a predetermined abnormal distribution.

11. The apparatus of claim 9, wherein the log analyzer is further configured to output a graph showing the distribution.

12. The apparatus of claim 9, wherein the connection stage pair comprises two connection stages sequentially executed during the system connection.

13. The apparatus of claim 8, wherein the log pattern identifier is further configured to generate, using the log data, records representing each connection stage, a start time of the connection stage, and an end time of the connection stage for each system connection, and to identify the plurality of connection patterns using the records.

14. The apparatus of claim 13, wherein:
the specific connection stage pair indicates a pair of two connection stages sequentially executed during the system connection, and
the log analyzer is further configured to identify a connection pattern indicating the specific connection stage pair among the plurality of connection patterns, check a distribution of a number of log data entries of the identified connection pattern with respect to a required time between the two connection stages, and detect the abnormal connection pattern based on the distribution.

15. An apparatus, intended for use in detecting an abnormal connection, comprising:
a log pattern identifier configured to identify a plurality of connection patterns, each indicating connection stages, from log data regarding a system connection; and
a log analyzer configured to perform at least one of:
a first log analysis detecting an abnormal connection stage pair, of the connection stages, indicated by a specific connection pattern among the plurality of connection patterns, and
a second log analysis detecting an abnormal connection pattern indicating a specific connection stage pair of the connection stages, among the plurality of connection patterns;
wherein the log pattern identifier and the log analyzer are implemented by at least one hardware processor.

16. A method, of detecting an abnormal connection, comprising:
identifying a plurality of connection patterns, each indicating connection stages, from log data regarding a system connection; and
performing a first log analysis for detecting an abnormal connection stage pair, of the connection stages, indicated by a specific connection pattern among the plurality of connection patterns;
wherein the identifying and the performing are implemented using at least one hardware processor.

17. The method of claim 16, wherein the first log analysis comprises:
identifying a connection stage pair indicated by the specific connection pattern; and
determining whether a distribution of a number of log data entries corresponding to the specific connection pattern, with respect to a required time between two connection stages of the identified connection stage pair, is normal.

18. The method of claim 17, wherein the determining whether the distribution is normal includes comparing the distribution with at least one of a predetermined normal distribution and a predetermined abnormal distribution.

19. The method of claim 17, further comprising outputting a graph showing the distribution.

20. The method of claim 17, wherein the connection stage pair comprises two connection stages sequentially executed during the system connection.

21. The method of claim 16, wherein the identifying comprises:
generating, using the log data, records representing each connection stage, a start time of the connection stage, and an end time of the connection stage for each system connection, and
identifying the plurality of connection patterns using the records.

22. The method of claim 21, wherein:
the specific connection pattern indicates two connection stages sequentially executed during the system connection;
the performing comprises:
identifying a pair of the two connection stages;
checking a distribution of a number of log data entries of the specific connective pattern with respect to a required time between the two connection stages, using the records; and
detecting the abnormal connection stage pair based on the distribution.

23. A method, of detecting an abnormal connection, comprising:
identifying a plurality of connection patterns, each indicating connection stages, from log data regarding a system connection; and
performing a log analysis for detecting an abnormal connection pattern indicating a specific connection stage pair of the connection stages, among the plurality of connection patterns;
wherein the identifying and the performing are implemented using at least one hardware processor.

24. The method of claim 23, wherein the log analysis comprises:
identifying a connection pattern, indicating the specific connection stage pair, among the plurality of connection patterns; and
determining whether a distribution of a number of log data entries corresponding to the identified connection pattern, with respect to a required time between two connection stages of the specific connection stage pair, is normal.

25. The method of claim 24, wherein the determining whether the distribution is normal includes comparing the distribution with at least one of a predetermined normal distribution and a predetermined abnormal distribution.

26. The method of claim 24, further comprising outputting a graph showing the distribution.

27. The method of claim 24, wherein the connection stage pair comprises two connection stages sequentially executed during the system connection.

28. The method of claim 23, wherein the identifying comprises:
generating, using the log data, records representing each connection stage, a start time of the connection stage, and an end time of the connection stage for each log regarding the system connection, and
identifying the plurality of connection patterns using the records.

29. The method of claim 28, wherein:
the specific connection stage pair indicates two connection stages sequentially executed during the system connection;
the performing comprises:
identifying a connection pattern indicating the specific connection stage pair among the plurality of connection patterns;
checking a distribution of a number of log data entries of the identified connection pattern with respect to a required time between the two connection stages; and
detecting the abnormal connection pattern based on the distribution.

30. A method, of detecting an abnormal connection, comprising:
identifying a plurality of connection patterns, each indicating connection stages, from log data regarding a system connection; and
performing at least one of:
a first log analysis detecting an abnormal connection stage pair, of the connection stages, indicated by a specific connection pattern among the plurality of connection patterns, and
a second log analysis detecting an abnormal connection pattern indicating a specific connection stage pair, of the connection stages, among the plurality of connection patterns;
wherein the identifying and the performing are implemented using at least one hardware processor.

31. A computer program stored in a non-transitory storage medium and configured to enable a hardware processor to implement operations comprising:
identifying a plurality of connection patterns, each indicating connection stages, from log data regarding a system connection; and
performing at least one of:
a first log analysis detecting an abnormal connection stage pair, of the connection stages, indicated by a specific connection pattern among the plurality of connection patterns, and
a second log analysis detecting an abnormal connection pattern indicating a specific connection stage pair, of the connection stages, among the plurality of connection patterns.
